(19) United States
(12) Patent Application Publication
(10) Pub. No.: US 2012/0327060 A1
(43) Pub. Date: Dec. 27, 2012

(54) DISPLAY DEVICE

(75) Inventors: Seiji Ohhashi, Osaka-shi (JP); Tsuyoshi Kamada, Osaka-shi (JP); Tetsuya Ide, Osaka-shi (JP); Shohei Katsuta, Osaka-shi (JP)

(73) Assignee: SHARP KABUSHIKI KAISHA, Osaka-shi, Osaka (JP)

(21) Appl. No.: 13/582,776

(22) PCT Filed: Jan. 5, 2011
(86) PCT No.: PCT/JP2011/050057

§ 371 Date: Sep. 5, 2012

(30) Foreign Application Priority Data
Mar. 10, 2010 (JP) 2010-053650

(51) Int. Cl. G06F 3/038

(52) U.S. Cl. 345/211; 345/204

(57) ABSTRACT

The present invention is a system, wherein a switching element is on/off controlled by means of a gate driver of a second substrate, electrical conductivity is made to a pixel electrode at a necessary position by means of a reference signal line, and data signals are applied to the data electrodes of a first substrate. An input terminal contact part connected to the drive signal terminal of the gate driver is electrically connected to the signal line contact part on the first substrate side, and the signal line contact part is connected to the first substrate side terminal merging part. Selection of a scanning line by means of the gate driver, and application of the signals to the data electrodes are performed by inputting required signals from the outside to the first substrate side terminal merging part. Because the input terminal contact part is constituted by several connecting lines, electrical connection between the first substrate and the second substrate is not required with respect to the all the scanning lines.

### TECHNICAL FIELD

The present invention relates to a display device. Priority is claimed on Japanese Patent Application No. 2010-053650, filed Mar. 10, 2010, the content of which is incorporated herein by reference.

### BACKGROUND ART

In a display device, for example, a display device that uses a liquid crystal material or organic electroluminescent material as a display medium layer, in an effort to achieve an increase in display capacity, active matrix type display devices are used, in which switching elements are provided for each of a plurality of pixels of a two-dimensional surface formed by a liquid crystal layer or an organic EL layer.

Also, an opposing data supply type liquid crystal display device has been proposed, in which active elements are provided for each pixel, as an improved type of STN liquid crystal display device.

The opposing data supply type liquid crystal display device is known as a type of liquid crystal display device in which, of a pair of substrates that are disposed so as to sandwich a liquid crystal layer, data (video) signals are supplied to a plurality of stripe-shaped data electrodes provided on the opposing substrate side, and a reference signal voltage (common voltage) is supplied to pixel electrodes connected to switching elements via a plurality of switching elements provided on the other side of the substrate.

FIG. 10 is a drawing that shows the basic structure of an opposing-data supply type liquid crystal display device of this type. In the basic structure shown in FIG. 10, pixel electrodes 101 are disposed in a matrix arrangement so as to oppose display regions on one substrate 100 that sandwiches the liquid crystal layer. The source sides of switching elements 102 that are connected to each pixel electrode 101 and that are arranged in the row direction (X direction in FIG. 10) are connected to a common bus line 103. A gate bus line 105 is connected to the gate sides of switching elements 102 that are arranged in the row direction. A plurality of stripe-shaped data bus lines 107 extending in the column direction (Y direction in FIG. 10) are provided on the liquid crystal layer side of a substrate 106 on the opposing side that sandwiches the liquid crystal layer. A terminal merging part 108 that is connected to the plurality of gate bus lines 105 is formed on the other substrate 100. A terminal merging part 109 that is connected to the plurality of data bus lines 107 is formed on the other substrate 106. The constitution is such that a flexible printed circuit (FPC) board or the like onto which a drive IC or the like is mounted, or such that a drive IC can be directly pressure-bonded onto each of the terminal parts 108 and 109.

In the opposing-data supply type liquid crystal display device shown in FIG. 10, a reference signal voltage (common voltage) is applied to the pixel electrodes 101 from the common bus line 103 via the switching elements 102 that have been placed in the on state by input from the gate bus lines 105. Each of the corresponding plurality of the data bus lines 107 receives input of a corresponding data (video) signal, which causes the liquid crystal existing at the regions of intersection between the data bus lines 107 and the pixel electrodes 101 to be driven so as to make a display.

In the opposing-data supply type liquid crystal display device having the basic structure shown in FIG. 10, however, it is necessary to perform the task of attaching an FPC board or a drive IC to both the substrate 100 and the substrate 106 and to pressure-bond corresponding terminals, and there is the problem of an expected increase in cost of the liquid crystal display device because of an increase in the number process steps for making pressure-bonding to the two substrates.

Given the above, an opposing-data supply type liquid crystal display device has been proposed of the type in which an FPC board or drive IC is attachable only to one of the substrates (refer to Patent Reference 1).

An example of the structure of this type of opposing-data supply type liquid crystal display device is shown in FIG. 11 to FIG. 13.

FIG. 11 shows the opposing-side first substrate 111, FIG. 12 shows the second substrate 112 on the side on which the switching elements are provided, and FIG. 13 shows the general interconnect structure in the condition in which the two substrates are attached together.

As shown in FIG. 11, a plurality of stripe-shaped data electrodes 113 extending in the column direction (Y direction) are provided on the liquid crystal layer side of the first substrate 111. First end parts 113a and second end parts 113b are provided on the two ends of the data electrodes 113 in the length direction. A connection pad 115 is formed on the first end part side and a connection pad 116 is formed on the second end part side.

Next, as shown in FIG. 13, a plurality of pixel electrodes 117 are formed in a matrix arrangement on the liquid crystal layer side of the second substrate 112, as are non-illustrated switching elements that are electrically connected to each of the pixel electrodes 117. Additionally, a plurality of stripe-shaped scanning lines 118 extending in the row direction along each of the pixel electrodes 117 and a reference signal lines 119 disposed in parallel with the scan lines 118 are formed on the liquid crystal layer side of the second substrate 112.

As shown in FIG. 12, on the second substrate 112, a sealing part 120, which is rectangularly frame shaped when seen in plan view is formed on the outside of the region in which the display pixel electrodes 117 are arranged in a matrix. The substrates 111 and 112 are attached together via this sealing part 120, and a liquid crystal layer is sandwiched and sealed between the two substrates. Additionally, so as to lead to the outside of the sealing part 120, input terminals 121 are formed on one end side of the scanning lines 118, and input terminals 122 are formed on one end side of the reference signal lines 119. These terminals, as shown in FIG. 13, are connected to a drive IC 123 mounted on the second substrate 112.

As shown in FIG. 12, a plurality of connection pads 124 are provided along the upper side and lower side of the sealing part 120 on the second substrate 112. As shown in FIG. 13, when the two substrates are attached together, these are connected to each of the data electrodes 113 of the first substrate 111, and input terminals 125 for the data electrodes are formed at the connection pads 124 on the lower side of the second substrate 112 so as to lead to the outside of the sealing part 120, these terminals being connected to the a drive IC 126 mounted on the second substrate 112. As shown in FIG. 12 and FIG. 13, a spare interconnection 130 for repairing interconnections is formed on the second substrate 112.

In the opposing data supply type liquid crystal display device having the above-noted constitution, each of the plurality of switching elements is formed between a reference signal line 119 and a pixel electrode 117, and a reference signal voltage (common voltage) is applied from the reference signal lines 119 to the pixel electrodes 117, via the switching elements that are placed in the on state by input from the scanning lines 118. Also, data (video) signals corresponding to each of the plurality of data electrodes 113 are input to the data electrodes 113 and displayed.

### CITATION LIST

### Patent Document

[Patent Document 1] Japanese Patent Laid-open Publication No. 2003-216062

### DISCLOSURE OF THE INVENTION

### Problems to be Solved by the Invention

The number of pixels in recent digital televisions, which is a field in which liquid crystals are being applied is on the increase to, for example, 1920×1080 or 1440×1080. In a liquid crystal panel having resolution to accommodate full HD (high definition), the total number of data bus lines, taking into consideration RGB for each pixel for a color display, including interconnections outside the screen display part, has come to be 1980×3.

If an opposing-data supply type liquid crystal display device having the structure shown in the above-described FIG. 11 to FIG. 13 is applied to a display panel such as this that accommodates full HD, the total number of connection pads 116 and 124 formed on the opposing substrate side becomes huge. Also, there are a large number of locations at which electric connections are made to the connection pads 116 and 124 between the two substrates. For this reason, there is concern regarding a drop in the yield when manufacturing the liquid crystal panel.

For example, to make pad connections between the pair of substrates of the liquid crystal panel, as described in Patent Reference 1, using spacers such as plastic beads and a conductive material that is formed by mixing and dispersing anisotropic conductive particles in a thermally cured resin, a conductive material is interposed between connection pads on opposing substrates while controlling the pressure and temperature conditions as the substrates to sandwich the liquid crystal layer are brought together, thereby achieving electrical connections between connection pads. However, because of the large number of the above-described connection pads, the probability of defective connections becomes great, leading to the risk of a decrease in yield.

The present invention was envisioned with consideration to the above-described problems, and has as an object to provide technology to provide a display device that, if an opposing-data supply type of liquid crystal display device is applied to a panel structure having a large number of pixels, by reducing overall number of connection pads between the pair of substrates, greatly reduces the number of locations that are connected between the two substrates, makes it difficult for defective connections to occur, and has a high yield.

### Means for Solving the Problems

(1) A display device of the present invention is provided in consideration of the above-described circumstances and includes a first substrate; a second substrate that is disposed in opposition to the first substrate; and a display medium layer that is provided between the first substrate and the second substrate. The display device further includes: a plurality of stripe-shaped data electrodes that extend in a column direction on the first substrate; a first substrate side terminal merging part that extends from a part of each of the data electrodes and is formed on the first substrate and to which a data signal corresponding to each of the plurality of data electrodes is input; a common bus line contact part that is formed on the first substrate so as to be connected to the first substrate side terminal merging part; a signal line contact part that is formed on the first substrate so as to be connected to the first substrate side terminal merging part; a plurality of scanning lines and a plurality of reference signal lines that extend in a row direction on the second substrate; a plurality of pixel electrodes that are disposed in a matrix arrangement on the second substrate; a plurality of switching elements in which on/off is controlled by the plurality of scanning lines, and which are disposed on the second substrate between the plurality of reference signal lines and the plurality of pixel electrodes; a gate driver formed on the second substrate and which has a plurality of output terminals and connects these output terminal to the scanning lines; an input terminal contact part formed on the second substrate and which makes connection to drive signal input terminals of the gate driver; and a reference signal line contact part formed on the second substrate so as to make connection to the plurality of reference signal lines. In a condition in which the first substrate and the second substrate are disposed so that the pixel electrodes disposed in the matrix arrangement and the strip-shaped data electrodes are in opposition, the common bus line contact part of the first substrate and the reference signal line contact part of the second substrate are electrically connected, and also the signal line contact part of the first substrate and the input terminal contact part of the second substrate are electrically connected.

(2) In the present invention, the display device may have a constitution in which the gate driver scans the scanning lines and on/off controls the switching elements that are provided along the corresponding scanning lines, a reference signal voltage is applied to the pixel electrodes from the reference signal lines, via the switching elements that are placed in the on state; and also data signals are input to the plurality of corresponding data electrodes, thereby controlling the transmissivity of the display medium layer that is interposed between the pixel electrodes and the data electrodes to which voltages are applied, so as to make a display.

(3) In the present invention, the display device may have the constitution in which a drive IC or a flexible printed board on which the drive IC is mounted is connected to the first substrate side terminal merging part.

(4) In the present invention, the display device may have a constitution in which the gate driver includes: a plurality of registers having a plurality of cascade-connected stages; a clock input terminal, a signal input terminal and output terminal are formed on each shift register; the shift registers are output circuits for switching the voltage at the output terminals to a high value or a low value and to which clock signals having different phases are supplied; a scan start signal being input to the first stage shift register and a scan end signal being input to the last stage shift register; and the plurality of clock signals, the scan start signal, and the scan end signal are input via an input terminal contact part formed on the second substrate.

(5) In the present invention, the display device may have a constitution in which the common bus line contact part of the first substrate and the reference signal line contact part of the second substrate are conductive material made by causing dispersion of spacers and anisotropic conductive particles in a resin, and wherein electrical connection is made by the interposing of the conductive material between the first substrate and the second substrate.

### Effects of the Invention

According to the present invention, in an opposing-data type display device, it is possible to greatly reduce the number of conducting parts between substrates that sandwich a display medium layer and the number of connection parts between the substrates.

Also, because it is possible to drive the display device if drive elements such as a drive IC is connected to only a first substrate side, compared to a constitution that is required to provide the drive elements on both substrates individually, it is possible to facilitate the mounting of the drive element.

### BRIEF DESCRIPTION OF THE DRAWINGS

FIG. 1A is a drawing showing the constitution of a display device according to an embodiment of the present invention.

FIG. 1B is a cross-sectional view showing an example of a conducting part between substrates.

FIG. 2 is a drawing showing an example of the circuit constitution of the opposing-side substrate provided in the display device of the same embodiment.

FIG. 3 is a drawing showing an example of the circuit constitution of the element-side substrate provided in the display device of the same embodiment.

FIG. 4 is a drawing showing the equivalent circuit constitution of the part that includes the pixel electrodes and the switching elements in the circuit constitution of the element-side substrate provided in the display device of the same embodiment.

FIG. 5 is a drawing showing an example of the circuit constitution when the two substrates provided in the display device of the same embodiment are joined.

FIG. 6 is a block circuit drawing showing an example of a multistage shift register when the display device of the same embodiment is driven.

FIG. 7 is a circuit diagram showing an example of a transistor placement structure in each stage of the shift register shown in FIG. 6.

FIG. 8 is a waveform diagram showing an example of an input output terminal voltage in the circuit of the shift register shown in FIG. 7.

FIG. 9 is a waveform diagram showing an example of a drive waveform and output pulses applied to the display device from the circuit shown in FIG. 7.

FIG. 10 is a drawing showing the constitution of an example of the basic structure of an opposing-data supply type liquid crystal display device.

FIG. 11 is a drawing showing the constitution of an opposing substrate side in the conventional structural example of an opposing-data supply type liquid crystal display device.

FIG. 12 is a drawing showing the constitution of an element substrate side in the conventional structural example of an opposing-data supply type liquid crystal display device.

FIG. 13 is a drawing showing the constitution of the circuit constitution when the two substrates are joined in the conventional structural example of an opposing-data supply type liquid crystal display device.

### BEST MODE FOR CARRYING OUT THE INVENTION

An embodiment of a liquid crystal display device according to the present invention, particularly the case of the present invention applied to the liquid crystal display device, will be described below, with references made to the drawings.

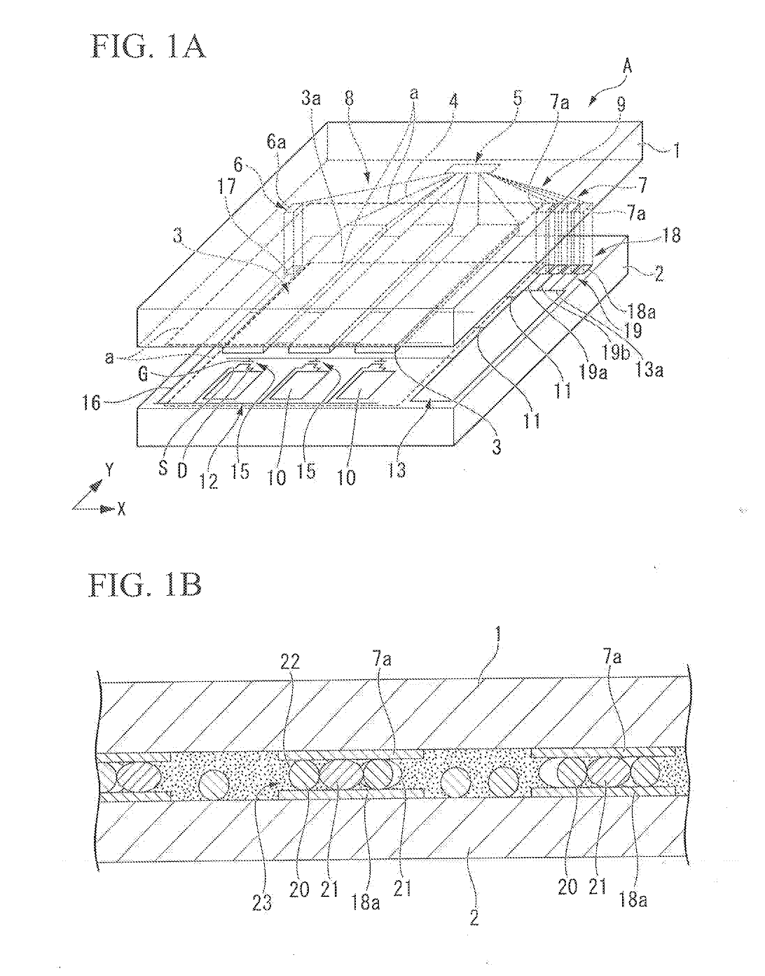

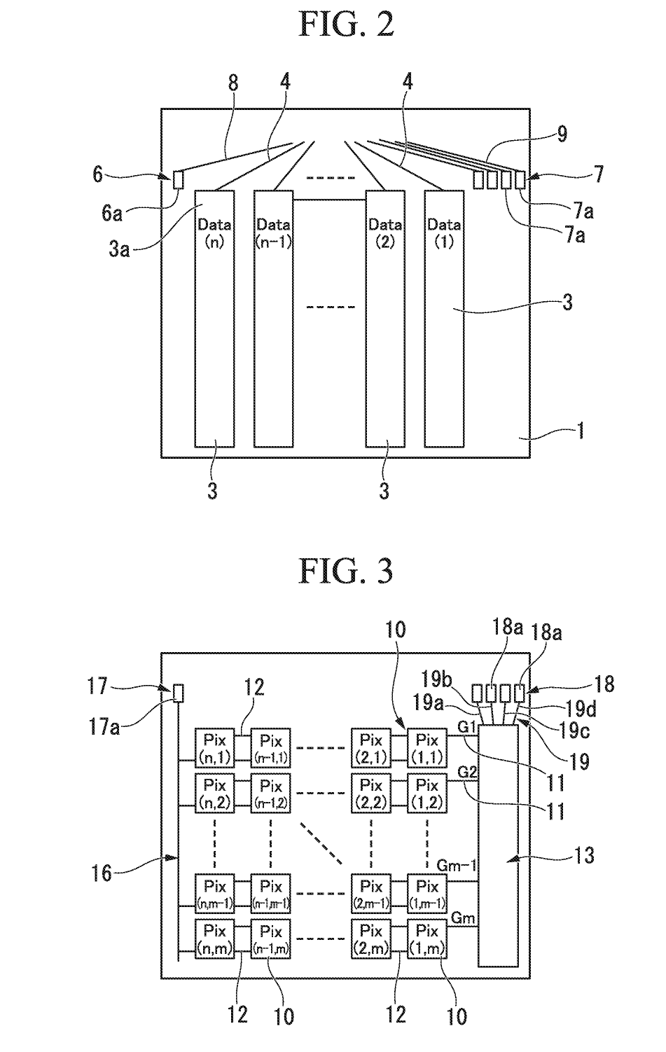

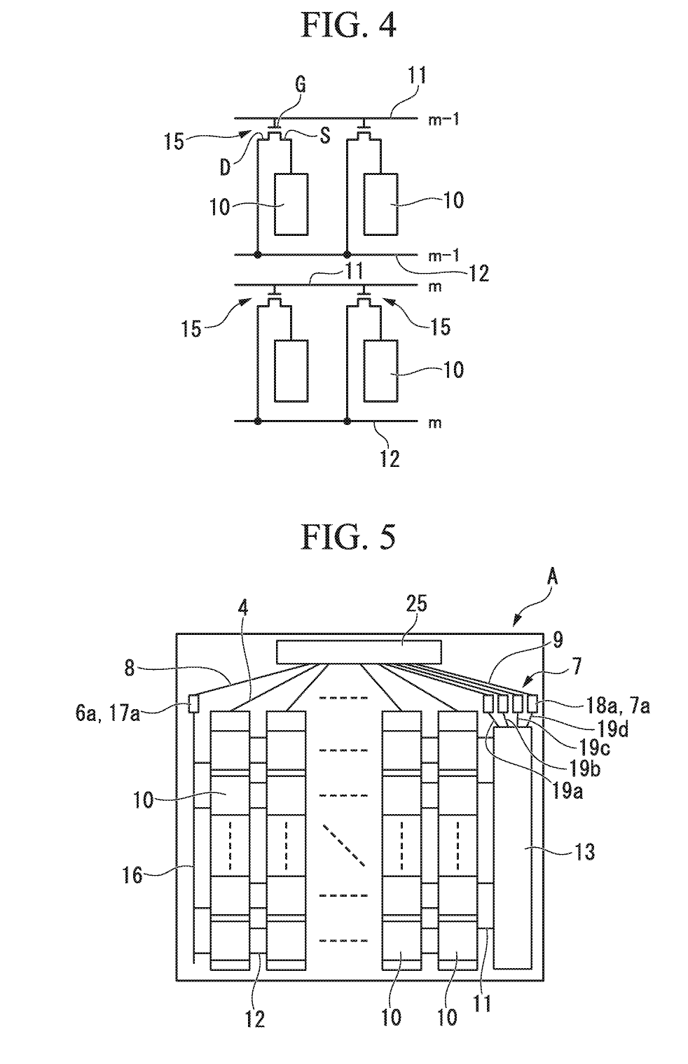

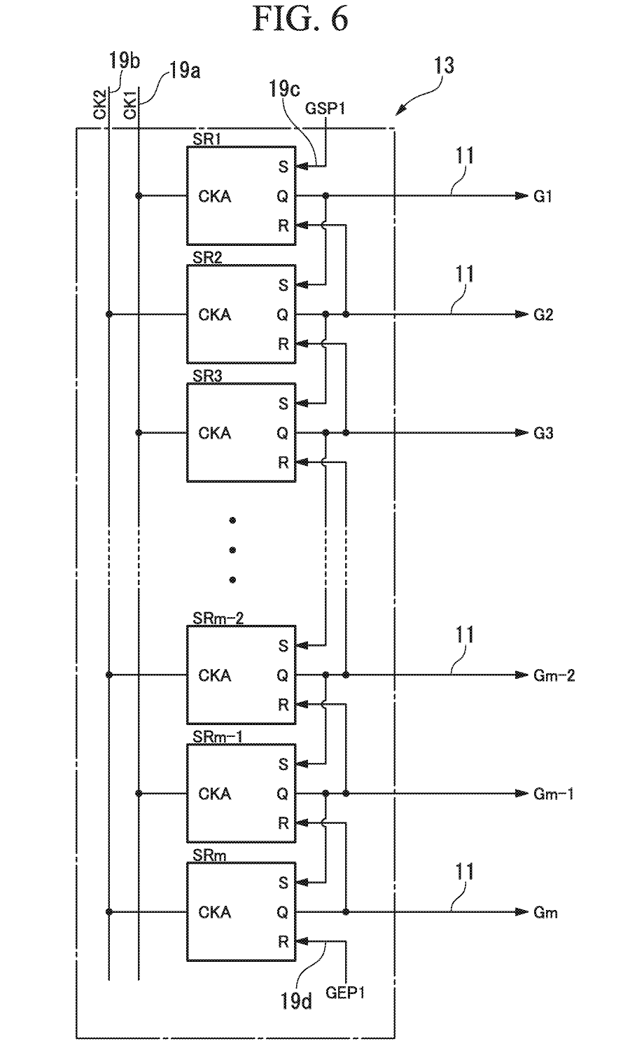

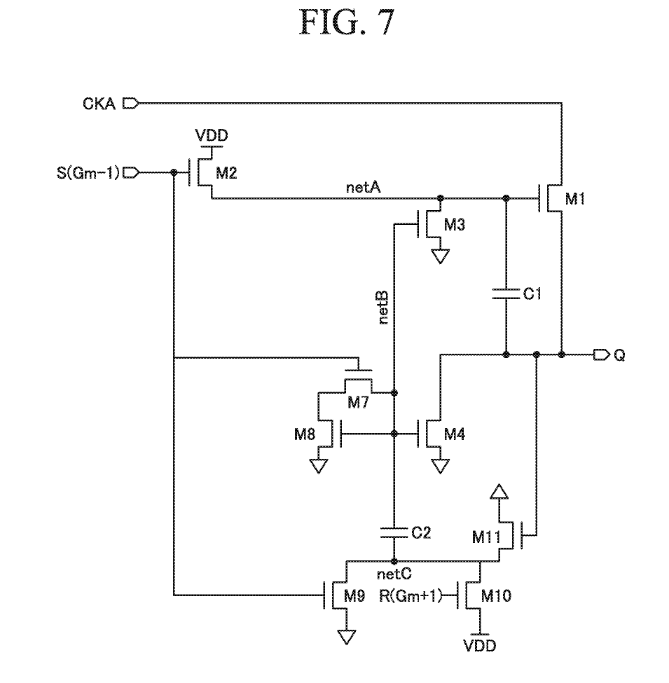

The display device of the present embodiment is applied to an opposing-data supply type display device in which a display medium layer, such as a liquid crystal layer, is sandwiched between a pair of substrates. FIG. 1A generally shows the pair of substrates in the opposing condition and generally shows the interconnects formed on both substrates. FIG. 1B is a cross-sectional view showing an example of a conducting part between substrates. FIG. 2 shows the interconnects on the opposing-side substrate. FIG. 3 shows the interconnects on the element-side substrate. FIG. 4 shows the interconnect structure surrounding the pixel electrode. FIG. 5 is a simplified drawing showing the overall circuit as a display device, with the two substrates combined. FIG. 6 shows an example of the constitution of a gate driver circuit applicable to a display device of the present embodiment, and FIG. 7 shows an example of an internal transistor circuit thereof.

In the display device A of the present embodiment, as shown in FIG. 1A, the constitution is such that a rectangularly shaped first substrate 1 and second substrate 2 are disposed in mutual opposition, so that a liquid crystal layer is sandwiched therebetween as a display medium layer. When the display medium layer sandwiched between the first substrate 1 and the second substrate 2 is a liquid crystal layer, a sealing material a is disposed around the peripheral part of the first substrate 1 and the second substrate 2, the liquid crystal layer being sealed by the surrounding two substrates 1 and 2 and the sealing material. FIG. 1A shows the main parts of the interconnect elements and electrode parts formed on the substrates 1 and 2. Although the first substrate 1 is usually constituted by a transparent glass substrate or the like, regarding the second substrate, depending on whether the display type is the transparent type or reflective type, either a transparent or a non-transparent type of substrate is selected and used.

As shown in FIG. 1A and FIG. 2, a plurality of stripe-shaped data electrodes (data lines) 3 extending in the column direction (Y direction in FIG. 1A) are provided on the surface of the display medium layer side of the first substrate 1. The one end 3a sides in the length direction of these data electrodes 3 are extended via extension interconnects 4 to the peripheral part side of the first substrate 1, forming a first substrate side terminal merging part 5 at the surrounding part center side. The first substrate side terminal merging part 5 is partitioned as a region in which terminal joinings are made with a drive IC 25, which will be described later, or a flexible printed board (FPC) or the like, onto which a drive IC and electronic components are mounted. The drive IC 25 is fixed to the first substrate 1 and drives the plurality of data electrodes 3 on the first substrate 1 side.

As shown in FIG. 1A, a common bus line contact part 6 is formed in a region between the data electrode 3 positioned at the left edge on the first substrate 1 of the plurality of data electrodes 3 arranged with a spacing therebetween in the X direction and the right side edge of the first substrate 1. A signal line contact part 7 is formed in a region between the data electrode 3 positioned at the right edge on the first substrate 1 and the right side edge of the first substrate 1.

Because the first substrate 1 as shown in FIG. 2 is a drawing mainly illustrating the interconnect structure while transparently showing the first substrate 1 shown in FIG. 1A, the first substrate 1 as shown in FIG. 2 is reversed left-to-right as seen from the bottom side in the first substrate 1 shown in FIG. 1A. When actually seen from the bottom side, in the first substrate 1 shown in FIG. 1A, there is a common bus line contact part 6 disposed to the right side and a signal line contact part 7 disposed at the left side, with respect to the arrangement of the plurality of data electrodes 3.

The common bus line contact part 6 has a terminal pad 6a formed on the display medium layer side of the first substrate 1, and the terminal pad 6a is connected to the first substrate side terminal merging part 5, via an extended interconnect 8, and is connected to the drive IC 25.

The signal line contact part 7 has four terminal pads 7a formed on the display medium layer side of the first substrate 1. Each of the terminal pads 7a is connected to the first substrate side terminal merging part 5 via the extended interconnects 9, and is connected to the drive IC 25.

In the second substrate 2 side, as shown in FIG. 1A and FIG. 3, a plurality of rectangularly shaped pixel electrodes 10 are formed in a matrix arrangement on the display medium layer side surface (upper surface) of the second substrate 2.

Of the pixel electrodes 10, a plurality of pixel electrodes 10 that are arranged with a prescribed spacing therebetween in the column direction (Y direction) are disposed so as to be opposite data electrodes 3 of the first substrate 1 side. The spacing of pixel electrodes 10 arranged in the row direction (X direction) is made the same as the spacing of the data electrodes 3 formed on the first substrate 1. Also, in FIG. 1A, in order to simplify the arrangement condition of the pixel electrodes 10, only three pixel electrodes are illustrated. In actuality, however, in accordance with the resolution of a display device to which application is made, an arbitrary number m of pixel electrodes in the column direction and an arbitrary number n of pixel electrodes in the row direction, as shown in FIG. 3, are disposed in a matrix arrangement so as to constitute the display device. For example, in the case of a display device having resolution for the full HD standard, in a color display using an RGB color filter, the number n would be 1980×3. Because in this embodiment, the number m×n of arranged pixel electrodes 10 can be adjusted as appropriate to the resolution required of the display device, in the present embodiment, what is shown is merely one example. The number arranged may be adopted as appropriate to the required resolution of the display device.

Next, in the vicinity of the pixel electrodes 10 disposed in a matrix arrangement on the second substrate 2, a plurality of scanning lines 11 extending in the row direction (X direction) and a plurality of reference signal lines 12 extending in the row direction are formed so as to run along each of the pixel electrodes 10 arranged in a matrix.

The scanning lines 11 each pass by the vicinity of the pixel electrodes 10 and are formed to extend up to the edge part of the second substrate 2, and are each connected to the output terminals of the gate driver 13 that are disposed so as to extend in the column direction (Y direction) at the right edge of the second substrate 2 shown in FIG. 1A. Because FIG. 3 shows the condition in which m scanning lines 11 are connected to the output terminal side of the gate driver 13, for convenience in illustration, the scanning lines 11 are distinguished by the reference symbols G1 to Gm.

Also, switching elements 15, such as thin-film transistors (TFTs) elements, are disposed between each scanning line 11 and the pixel electrode 10 that is in the vicinity thereof. As shown in FIG. 4, the gate G of each switching element 15 is connected to a scanning line 11, and the drain D of each switching element 15 is connected to a pixel electrode 10.

The reference signal lines 12, as shown in FIG. 1A and FIG. 4, are formed along the row direction so as to pass in the vicinity of each pixel electrode 10 in parallel with the scanning lines 11, and each thereof is connected to the source S of a switching element 15 in the vicinity of each pixel electrode 10. Additionally, each of the reference signal lines 12 is connected to an extended interconnect 16 formed at the left edge side of the second substrate 2. This extended interconnect 16 is formed so as to extend in the column direction at the left edge side of the second substrate 2, and to extend up to the corner part of the left edge side of the second substrate 2, at which position a reference signal line contact part 17 having a terminal pad 17a is formed. Also, the formation position of this terminal pad 17a is overlapped, when seen in plan view, with the position of the terminal pad 6a formed at the first substrate 1 side, in the condition in which the first substrate 1 and the second substrate 2 are disposed so as to be in mutual opposition.

Next, as shown in FIG. 1A and FIG. 3, at a position at one edge side of the second substrate 2 and corresponding to one edge side of the scanning lines 11, a gate driver 13 is disposed along the column direction (Y direction) of the second substrate 2, and an input terminal contact part 18 is formed in the vicinity of one edge of the gate driver 13. The input terminal contact part 18 has four terminal pads 18a formed thereon, the four terminal pads 18a being connected to one end (input terminal side) of the gate driver 13, by the connection lines 19a to 19d. The positions of formation of the terminal pads 18a are positions such that, in the condition in which the first substrate 1 and the second substrate 2 are disposed so as to be in mutual opposition, they overlap with the positions of the four terminal pads 7a formed on the first substrate 1 side when seen in plan view.

Next, the connection structure between the terminal pads 17a of the first substrate 1 and the terminal pads 18a of the second substrate 2 when the first substrate 1 and the second substrate 2 are brought into opposition with the display medium layer interposing therebetween and are joined as one is the structure shown in FIG. 1B.

That is, connection is made by a conductive material 23 in which a predetermined amount of spherical spacers 20 and anisotropic conductive particles 21 are dispersed within a resin material 22. Although FIG. 1B shows a part of the cross-sectional structure of three terminal pads 18a and terminal pads 7a formed on the second substrate 2, with regard to a connection part between the terminal pad 6a of the first substrate 1 and the terminal pad 17a of the second substrate 2, one terminal pad is formed on both of the substrates, and the structure is equivalent.

In the conductive material 23 of the present embodiment, the anisotropic conductive particles 21 are constituted by compound particles having a conductive layer of Au or the like covering the surface of plastic particles having a prescribed particle diameter, these being interposed between the terminal pad 6a of the first substrate 1 and the terminal pad 17a of the second substrate 2 by the pressure applied when joining together the first substrate 1 and the second substrate 2, and they themselves elastically deforming so as to make contact with and electrically connect both pads. The conduction between the terminal pads 7a of the first substrate 1 and the terminal pads 18a of the second substrate 2 is also a connection structure that uses the conductive material 23 in the same manner. If the average number of dispersed anisotropic conductive particles 21 contained in the conductive material 23 is D/mm², with anisotropic conductive particles 21 having a diameter of μ, although it is possible to disperse and mix within the range of D from several to several hundred, this mixed amount is only one example, and it is possible, of course, to constitute the conductive material 23 with a mixture of a number of particles that is sufficient for a low-resistance connection as the display device A.

By adopting the conduction structure shown in FIG. 1B, in the condition in which the first substrate 1 and the second substrate 2 are brought into opposition with an interposing display medium layer and the two are joined as one using a sealing material or the like, the reference signal lines 12 of the second substrate 2 are electrically connected to the first substrate side terminal margining part 5 via the extended interconnect 16, the terminal pad 17a, the conductive material 23, the terminal pad 6a, and the extended interconnect 8 and electrically connected to the drive IC 25. In the same manner, the drive signal input terminals 13a side of the gate driver 13 are connected to the first substrate side terminal merging part 5 via the connection lines 19, the terminal pads 18a, the conductive material 23, the terminal pads 7a, and the extended interconnects 9, and electrically connected to the drive IC 25.

Also, the drive IC 25 for driving the display device A of the present application is terminal connected to the first substrate side terminal merging part 5 in the first substrate 1. The drive IC 25 supplies data signals to the plurality of data electrodes 3 on the first substrate 1, issues a selection command to the gate driver 13 regarding which scanning line 11 is to be selected, and functions to apply a reference signal voltage to the reference signal lines 12.

The drive IC 25 connected to the first substrate side terminal merging part 5 may be a single IC. Alternatively, the drive IC 25 may be a compound drive module in which a drive IC and other electronic components are mounted to an FPC board or the like. Although the detailed constitution thereof is not a requirement of the present embodiment, it is sufficient that it has the necessary functionality to drive the display device A.

As shown in FIG. 1A, the sealing material a for sealing the liquid crystal disposed between the substrates 1 and 2 is formed to be rectangular frame shape when seen in plan view, so as to surround the periphery of the pixel electrodes 10 arranged in a matrix. Each side of the sealing material a is disposed to the inside of the gate driver 13 and the terminal pads 18a on the side on which the gate driver 13 and terminal pads 18a are disposed on the substrate 2. Each side of the sealing material a is disposed to the inside of the terminal pad 17a on the side on which the terminal pad 17a is disposed on the substrate 2. Each side of the sealing material a is disposed to the inside of the position of mounting the drive IC 25 on the side on which the drive IC 25 is disposed on the substrate 1.

In the display device A of the present embodiment, although a color filter with an RGB arrangement is usually disposed between the first substrate 1 and the data electrodes 3 if the constitution is that of a color display, the color filter is not shown in the present embodiment. Also, because in recent years liquid crystal display devices using color-filter-on-array technology in which a color filter is provided on the second substrate 2 have been provided, it is possible to adopt a structure in which a color filter is provided on the second substrate 2 side.

Next, an example of the preferable shift register structure applied to the gate driver 13 of the present embodiment will be described, with references made to FIG. 6 to FIG. 8.

FIG. 6 is a block circuit diagram showing an example of the gate driver 13 having a basic structure that is the connection of multiple stages of shift registers SR.

In the gate driver 13 in this example, there are shift registers SR1 to SRm, these being a plurality of 1st to the m-th stages, which are substantially the same connected in cascade. Each shift register SR is provided with a clock input terminal CKA, and output terminal Q, and input terminals S and R.

As shown in FIG. 6, the clock signal CK1 is input via the connection line 19a to the clock input terminals CKA of odd-numbered stages of shift registers SR, such as the 1st, the 3rd, and the 5th, and the clock signal CK2 is input via the connection line 19b to the clock input terminals CKA of even-numbered stages of shift registers SR, such as the 2nd, the 4th, and the 6th. The scan start signal GSP1 is input via the connection line 19c to the input terminal S of the 1st stage shift register SR1. A divided output from the output terminal Q of the next shift register SR is input to the input terminals R of the first and subsequent shift register SR. A divided output from the output terminal Q of the previous stage shift register SR is input to the input terminal S of the 2nd and subsequent stage shift register SR. The scan end signal GEP1 is input via the connection line 19d to the input terminal R of the last stage of shift register SRm.

Also, each of the output terminals Q of the 1st to the m-th stage shift registers SR is connected to each of the scanning lines 11 formed on the second substrate 2.

In the display device A of the present embodiment, because the constitution is such that the four connection lines 19a, 19b, 19c, and 19d to be connected to the terminal side of the gate driver 13 are connected to the shift registers SR1 to SRm as shown in FIG. 6, the constitution is such that the drive IC 25 to be connected to the first substrate side terminal merging part 5 is provided with the capability of, in addition to supplying data signals, generating the clock signals, the scan start signal, and the scan end signal. Alternatively, the constitution may be such that the drive IC 25 is given only the capability of supplying data signals, and a flexible printed board having other elemental components and a pulse generator or the like in addition to the drive IC 15 is connected to the first substrate side terminal merging part 5.

An example of the transistor circuit structure internal to each of the shift registers SR shown in FIG. 6 is shown in FIG. 7.

In the transistor circuit shown in FIG. 7, transistors M1 to M11, which are n-type TFTs are formed, disposed, and mutually interconnected on the substrate 2. A clock signal is input to the source of the transistor M1, and the drain of the transistor M2 is connected via netA to the gate of the transistor M1. A bias voltage VDD is applied to the source of the transistor M2, and the output of the previous stage (S(Gm−1)) is input to the gate of the transistor M2.

The gate of the transistor M11 is connected via the output terminal Q to the drain of the transistor M1. A capacitor C1 is connected between the output terminal Q and the node netA.

The source of the transistor M3 is connected to the node netA, and the gate of the transistor M3 is connected via the node netB to the source of the transistor M7 and the gates of the transistors M4 and M8. The node netB is connected to the node netC via a capacitor C2. The source of the transistor M9, the source of the transistor M11, and the drain of the transistor M10 are connected to this node netC, and the bias voltage VDD is applied to the source of the transistor M10.

The transistor M8 shown in FIG. 7 is designed to have transistor characteristics similar to those of the transistor M3 or M4. Methods that can be envisioned for doing this are, for example, making the W/L (channel width/channel length) of the transistors M3, M4, and M8 the same, or adopting a structure that makes the layout dispositions of the transistor M8 be close to at least one of the transistors M3 and M4.

As a simplification in the circuit shown in FIG. 7, the initial (immediately before operating the circuit) threshold voltage Vth of transistors M3, M4, and M8 are made the same, and the amount of threshold voltage shift (Vth+α, where α>0) after continuously operating the circuit for some time is taken as being the same.

As shown in FIG. 6, the scan start signal GSP1 or the output signal from the previous stage is input to the input terminal S of the shift register SR1. Two drive pulses, CK1 and CK2, having different phases, are input to the clock signal input terminals CKA of each stage of shift registers SR. For example, the drive pulse CK1 is input to the clock input terminal CKA of odd-numbered stages of shift registers SR, and the drive pulse CK2 is input to the clock input terminal CKA of even-numbered stage of shift registers SR.

The signals output from the output terminals Q of each stage of shift register SR are each applied to the corresponding scan lines G1 to Gm and output to the input terminal S of the next stage of shift register SR.

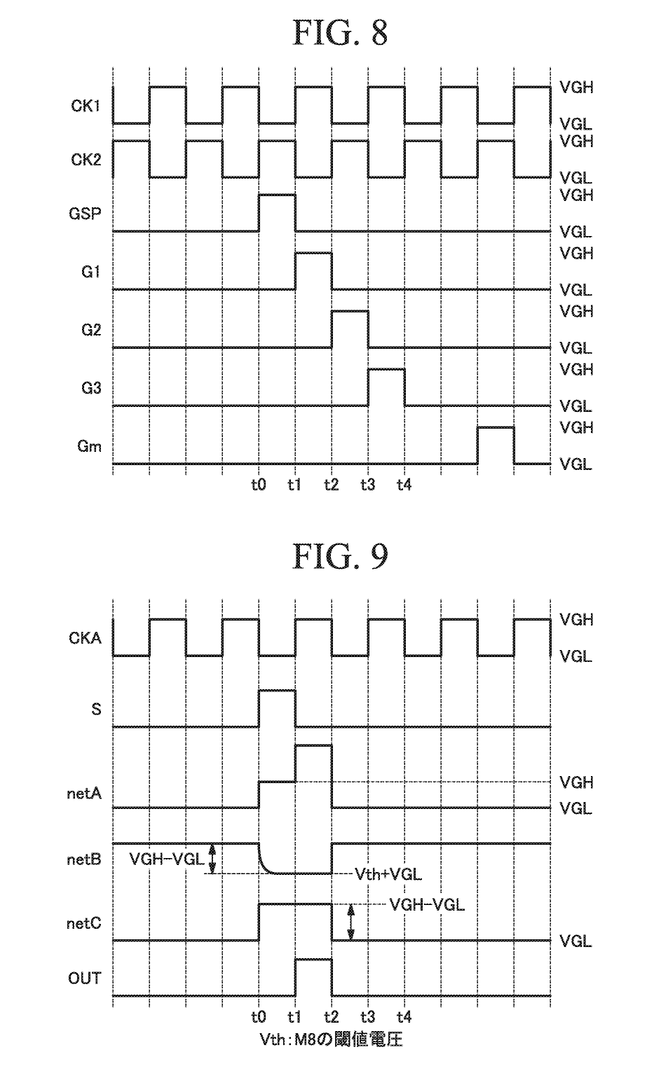

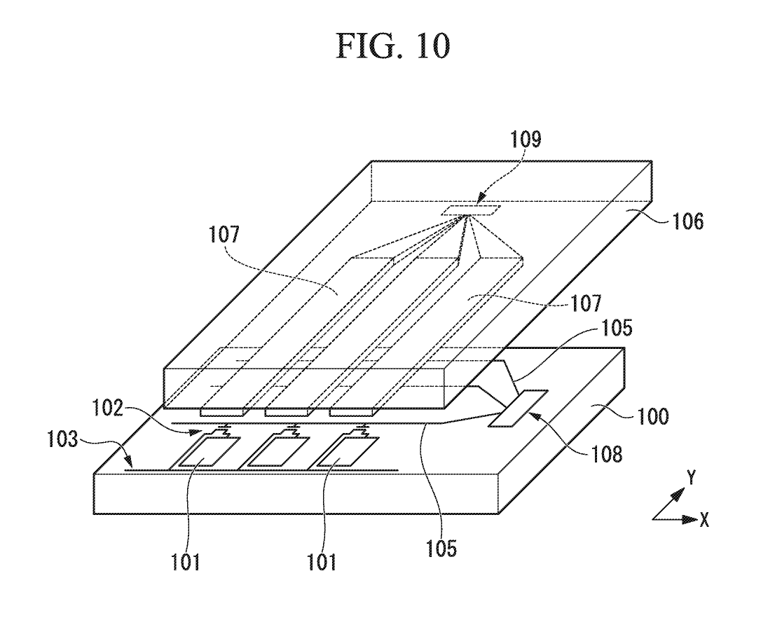

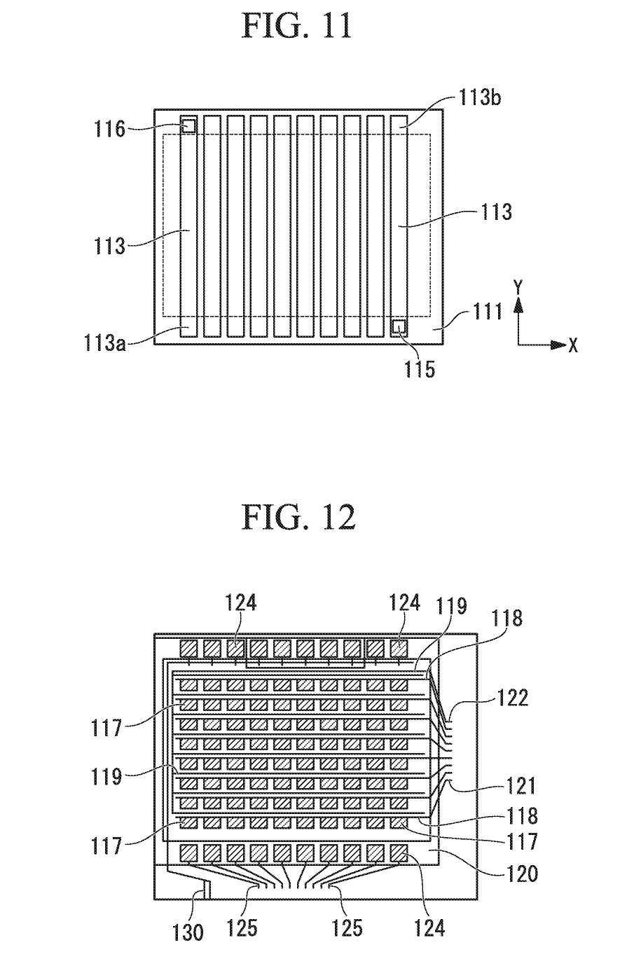

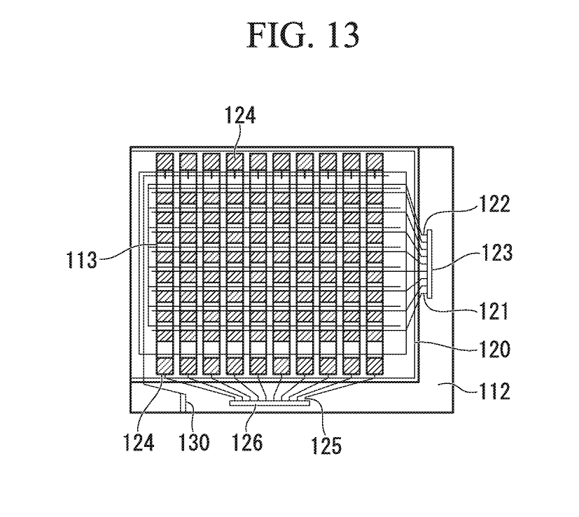

Next, the operation of the shift register circuit shown in FIG. 6 and FIG. 7 will be described, with references made to FIG. 8 and FIG. 9.

First, at time t0, the potential on the scan start signal GSP1 changes to VGH. When this potential is applied to the input terminal S of the 1st stage shift register SR1, the transistors M2, M7, and M9 go into the conducting state. When this occurs, the potential on the node netA is set to the potential VGH of the power supply line VDD.

Therefore, although the transistor M1 goes into the conducting state, because the terminal voltage at the input terminal CKA is VGL, the terminal voltage at the output terminal Q remains as VGL. Also, because the transistor M7 goes into the conducting state, and the gate and the drain of the transistor M8 are shorted together, the transistor M8 is in the state of being connected as a diode.

Therefore, current flows from the gate/drain terminal (node netB) of the transistor M8 into the source terminal of the transistor M8, the node netB gradually decreases, and continues to decrease until the voltage becomes VGL+Vth_M8. In this case, Vth_M8 is the threshold voltage of the transistor M8, such that Vth_M8>0 and Vth_M8>VGL.

Under this condition, the gate-source voltage Vgs of the transistor M8 becomes Vgs=Vth_M8, the non-conducting state occurs. With regard to the transistors M3 and M4 as well, because the threshold voltage is made the same as that of the transistor M8, similar to the transistor M8, the non-conducting state occurs.

Also, because the transistor M9 is in the conducting state, the node netC is set to source terminal voltage VGL of the transistor M9.

Next, at time t1, the voltage of the scan start signal GSP changes to VGL, and the drive pulse CK1 voltage changes to VGH. When this occurs, the transistors M2, M7, and M9 go into the non-conducting state.

Also, because the drain terminal voltage of the transistor M1 is set to VGH, because of parasitic capacitance between the gate and drain of the transistor M1, the voltage at the node netA is pulled up from VGH, so that the potential at the node netA is set to a potential that is higher than VGH (ideally 2 times the voltage of VGH, although the voltage does not rise that high, because of the individual parasitic capacitances and resistance and the like at the node netA, the input terminal CKA, the output terminal Q, and transistor M1).

Because of this, the potential VGH of the input terminal CKA is output via the transistor M1 to the output terminal Q, and this potential is applied to the corresponding scanning line G1 and, until time t2, at which the potential of the drive pulse CK1 changes to VGL, the scanning line G1 is in the selected state. When the voltage on the output terminal Q exceeds the threshold voltage of the transistor M11, the transistor M11 goes into the conducting state, and the node netC changes to the source terminal voltage VGL of the transistor M11, enabling holding of the state at time t0. When this occurs, because it is possible to hold the node netC in the state of time t0, the node netB, which is the other terminal of the capacitor C2, is also held at the state of time t0, and the transistors M3 and M4 go into the non-conducting states.

Also, the voltage at the output terminal voltage Q of the shift register SR1 is applied to the input terminal S of the next stage shift register SR2, and, because the drive pulse CK2 voltage is applied to the input terminal CKA, the shift register SR2 goes into the same state as the state of the shift register SR1 at time t0.

Next, at time t2, because the drive pulse CK1 potential changes to VGL, voltage at the input terminal CKA of the shift register SR1 is set to VGL. When this occurs, because the potential at the node netA is set to a potential higher than VGH, and the drain terminal of the transistor M1 is set to VGL, current flows in the direction from the source terminal to the drain terminal of the transistor M1, and the potential at the drain terminal (output terminal Q) of the transistor M1 drops down to VGL. Therefore, the potential on the scanning line G1 also drops to VGL, and the scanning line G1 goes into the non-selected state. Accompanying this, the transistor M11 goes into the non-conducting state.

Also, when this occurs, at the next stage shift register SR2, VGH is applied to the input terminal CKA, placing the next stage shift register SR2 in the same state as 1st stage shift register SR1 at time t1 and, because VGH is applied to the scanning line G2, the scanning line G2 goes into the selected state.

As a result of the above, because the shift register SR1 has VGL applied to its input terminal R and the transistor M10 is in the conducting state, the node netC is set to the power supply line VDD voltage VGH. Therefore, the voltage at node netB, which is the other terminal of the capacitor C2, rises from the state at time t1 by the increased amount of the voltage at the node netC (the amount of VGH−VGL). When this occurs, because of the relationship VGH>VGL, the voltage at the node netB becomes Vth_M8+VGH−VGL, and the transistors M3 and M4 goes into the conducting state. Thus, the potential at the node netA is set to the source terminal voltage VGL of the transistor M3, and the transistor M1 goes into the non-conducting state.

Also, at the 3rd stage shift register SR3, the state occurs that is the same as that of the 2nd shift register SR2 at time t1.

Next, at time t3, the drive pulse CK1 changes to VGH, and the drive pulse CK2 changes to VGL. When this occurs, although the voltage at the input terminal CKA of the 1st stage shift register SR1 is set to VGH, netB and netC are respectively held at Vth_M8+VGH−VGL and VGH, and the transistors M3 and M4 are maintained in the conducting state. Thus, the gate terminal voltage (netA) of the transistor M1 is set to VGL, the transistor M1 going into the non-conducting state, and the output terminal Q is held at VGL, which is the source terminal voltage of the transistor M4.

The 2nd stage shift register SR2 goes into the same state as the 1st stage shift register at time t2, VGL is applied to the scanning line G2, and the scanning line G2 going into the non-selected state.

When this occurs, at the 3rd stage shift register SR3, VGH is applied to the input terminal CKA, placing the 3rd stage shift register SR3 in the same state as the 2nd stage shift register SR2 at time t1. Thus, because VGH is applied to the scanning line G3, the scanning line G3 goes into the selected state.

Although the description for time t4 and thereafter will be omitted, as described above, the m-th shift register SRm at time t goes into the state of the previous (one stage previous) shift register SRm−1 at time t−1 (the state shifts), so that the m-th shift register SRm functions as a shift register.

Also, at the last stage shift register SRm, because there is no subsequent shift register stage, at time t2, for example, it cannot occur that the voltage at the input terminal R of the shift register SR1 rises to VGH, the transistor M10 goes into the conducting state, and the voltage on netC rises to VGH.

Therefore, at the input terminal R of the shift register SRm, after changing to the same state as the shift register SR1 at time t1, by inputting the scan end signal GEP1, the state changes to the state of the shift register SR1 at time t2. As a result, the shift register SRm can place the scanning line Gm into the non-selected state and complete the scanning of the scanning lines G1 to Gm. Then, by selecting the scanning lines G1 to Gm again at the timing of the next scan, it is possible to operate as the gate driver 13.

If we look at the voltage waveform at the node netB in FIG. 9, as described regarding the present embodiment, a substantially constant voltage VGH is applied. As a result, the threshold values of the transistors M3, M4, and M8 are shifted in the positive direction. In this case, the following Equation (1) obtains.

Ids=W/Lx×μ×Cox×(Vgs−Vth_{—}M8−Vds/2)×Vds (1)

In the above Equation (1), μ is the degree of movement, Cox is the gate oxide film capacitance, Vgs is the gate-source voltage, Vth is the threshold voltage, and Vds is the drain-source voltage.

Also, because the transistors M3 and M4 are designed to have transistor characteristics similar to those of the transistor M8, their threshold value shit is similar to that of the transistor M8. However, netB in the shift register circuit of the present embodiment (the gate terminal voltage of the transistor M8), with the exception of the period of time in which it is set to Vth_M8, is set to Vth_M8+VGH−VGL over substantially all periods of time, so that Equation (1) can be rewritten as follows.

Ids=W/L×μ×Cos×{(Vth_{—}M8+VGH−VGL)+VGL−Vth_{—}M8−Vds/2}×Vds=W/L×μ×Cox×(VGH−Vds/2)×Vds (2)

That is, there is no dependence on the threshold voltage of the transistor M8. Because Equation (2) would be the same for rewritten equations for the transistors M3 and M4, it can be seen that there is no relationship to threshold value shift (there is no deterioration of transistor drive capability).

Therefore, by using the shift register SR having the transistor circuit shown in FIG. 7, even if individual transistors cause a threshold value shift, it is possible to maintain functionality as a shift register SR.

By the above-described constitution of the gate driver 13 having the multistage shift registers SR, it is possible to sequentially scan the scanning lines 11 in the display device A of the present embodiment.

In the display device A of the present embodiment, therefore, by inputting data signals from the drive IC 25 connected to the first substrate side terminal merging part 5 to the plurality of data electrodes 3 of the first substrate 1 so as to drive the gate driver 13 and select scanning lines 11, simultaneously setting required switching elements 15 to the on state and applying the reference signal voltage (common voltage) from the reference signal lines 12 to the pixel electrodes 10 connected to the switching elements 15, it is possible to control the orientation of the liquid crystal molecules of the liquid crystal layer existing at the intersecting parts between the data lines 3 to which signals are input and the pixel electrodes 10 to which the reference signal voltage is applied, thereby controlling the light transmissivity, and achieving display of the desired video or the like.

According to the display device A of the present embodiment, in addition to enabling display of video or the like by the above-described drive, it is possible to have a constitution in which the input terminal contact part 18 connecting to the drive signal input terminals of the gate driver 13 are constituted by several, for example, by four connecting lines 19a to 19d. It is therefore not necessary to make conductivity with regard to all the scanning lines 11 by conductive material between the first substrate 1 and the second substrate 2, and the structure of the present embodiment can be achieved by substantially four conductive parts between the substrates. By doing this, it is possible to greatly reduce the number of connections between the substrates.

Therefore, in a high-definition display device that can accommodate the resolution of full HD, even in a display device structure having a very large number of scanning lines, it becomes possible to greatly reduce the number of connecting parts between the substrates, and to expect the effect of an improvement in yield. For example, in the case of a high-definition display device, even if it is necessary to have several hundred to thousand scanning lines, considering a color display constitution using an RGB type color filter, because connections for scanning lines between the substrates 1 and 2 can be completed by conductivity using the four connection lines 19a to 19d, thereby greatly contributing to a saving of labor.

Also, because drive of the display device A is possible if connection is made of the drive elements of a drive IC or the like to only the first substrate side terminal merging part 5 at the first substrate 1 side, compared to conventional art, which required drive elements to be provided separately on both substrates 1 and 2, there is the effect of facilitating the mounting of the drive elements.

### INDUSTORIAL APPLICABILITY

The display device of the present invention is preferable for application to a high-resolution display device such as for full HD, and enables the effect of improved yield by reducing the number of connections in conductive parts between the substrates.

### DESCRIPTION OF REFERENCE NUMERALS

1: First substrate
2: Second substrate
3: Data electrode
4: Extended interconnect
5: First substrate side terminal merging part
6: Common bus line contact part
6a: Terminal pad
7: Signal line contact part
8, 9: Extended interconnect
10: Pixel electrode
11: Scanning line
12: Reference signal line
13: Gate driver
13a: Drive signal input terminal
15: Switching element
G: Gate
S: Source
D: Drain
17: Reference signal line contact part
17a: Terminal pad
18: Input terminal contact part
18a: Terminal pad
19: Connecting line
19a, 19b, 19c, 19d: Connecting line
21: Anisotropic conductive particle
25: Drive IC

1. A display device comprising:
a first substrate;
a second substrate that is disposed in opposition to the first substrate; and
a display medium layer that is provided between the first substrate and the second substrate,
wherein the display device further comprising;
a plurality of stripe-shaped data electrodes that extend in a column direction on the first substrate;
a first substrate side terminal merging part that extends from a part of each of the data electrodes and is formed on the first substrate, and to which a data signal corresponding to each of the plurality of data electrodes is input;
a common bus line contact part that is formed on the first substrate so as to be connected to the first substrate side terminal merging part;
a signal line contact part that is formed on the first substrate so as to be connected to the first substrate side terminal merging part;
a plurality of scanning lines and a plurality of reference signal lines that extend in a row direction on the second substrate;
a plurality of pixel electrodes that are disposed in a matrix arrangement on the second substrate;
a plurality of switching elements in which on/off is controlled by the plurality of scanning lines, and which are disposed on the second substrate between the plurality of reference signal lines and the plurality of pixel electrodes;
a gate driver formed on the second substrate and which has a plurality of output terminals and connects these output terminals to the scanning lines;
an input terminal contact part formed on the second substrate and which makes connection to drive signal input terminals of the gate driver; and
a reference signal line contact part formed on the second substrate so as to make connection to the plurality of reference signal lines;
wherein, in a condition in which the first substrate and the second substrate are disposed so that the pixel electrodes disposed in the matrix arrangement and the strip-shaped data electrodes are in opposition, the common bus line contact part of the first substrate and the reference signal line contact part of the second substrate are electrically connected, and also the signal line contact part of the first substrate and the input terminal contact part of the second substrate are electrically connected.

2. The display device according to claim 1, wherein the gate driver scans the scanning lines and on/off controls the switching elements that are provided along the corresponding scanning lines, a reference signal voltage is applied to the pixel electrodes from the reference signal lines, via the switching elements placed in the on state, and also data signals are input to the plurality of corresponding data electrodes, thereby controlling the transmissivity of the display medium layer that is interposed between the pixel electrodes and the data electrodes to which voltages are applied, so as to make a display.

3. The display device according to claim 1, wherein a drive IC or a flexible printed board on which the drive IC is mounted is connected to the first substrate side terminal merging part.

4. The display device according to claim 1, wherein the gate driver comprises a plurality of registers having a plurality of cascade-connected stages;
a clock input terminal, a signal input terminal and output terminal are formed on each shift register;
the shift registers are output circuits for switching the voltage at the output terminals to a high value or a low value and to which clock signals having different phases are supplied;
a scan start signal is input to the first stage shift register and a scan end signal being input to the last stage shift register; and
the plurality of clock signals, the scan start signal, and the scan end signal are input via an input terminal contact part formed on the second substrate.

5. The display device according to claim 1, wherein the common bus line contact part of the first substrate and the reference signal line contact part of the second substrate are a conductive material made by causing dispersion of spacers and anisotropic conductive particles in a resin, and
an electrical connection is made by the interposing of the conductive material between the first substrate and the second substrate.
